(19) United States
(12) Patent Application Publication
(10) Pub. No.: US 2012/0153190 A1
(43) Pub. Date: Jun. 21, 2012

(54) METHOD FOR MANUFACTURING WAVELENGTH CONVERSION ELEMENT

(75) Inventors: Akifumi Aono, Ehime (JP); Kiminori Mizuuchi, Ehime (JP)

(73) Assignee: PANASONIC CORPORATION, Kadoma-shi, Osaka (JP)

(21) Appl. No.: 13/392,805

(22) PCT Filed: Aug. 6, 2010
(86) PCT No.: PCT/JP2010/004948

§ 371 Date: Feb. 27, 2012

(30) Foreign Application Priority Data
Aug. 28, 2009 (JP) 2009-197506

(51) Int. Cl. G21G 5/00

(52) U.S. Cl. 250/492.1

(57) ABSTRACT

Provided is a method for manufacturing a wavelength conversion element 3 for converting a fundamental wave into a second harmonic wave, the method including the aging step (step 4) of irradiating a nonlinear optical crystal substrate 1 with a first light beam 4 having the same wavelength as the fundamental wave until the amount of variation per unit time in the phase matching temperature becomes a predetermined reference value or smaller while keeping the temperature of the nonlinear optical crystal substrate 1 at around the phase matching temperature after forming a periodical polarization-reversed structure in the nonlinear optical crystal substrate 1 (step 2).

### TECHNICAL FIELD

The present invention relates to a method for manufacturing a second harmonic wave generation wavelength conversion element (hereinafter, will be referred to as a SHG wavelength conversion element or a wavelength conversion element) used for, for example, a laser light source device.

### BACKGROUND ART

Gas laser light source devices such as argon gas laser and krypton gas laser have been conventionally known. However, the devices have low energy conversion efficiency of 0.1% and require a cooling mechanism. Thus, the devices are difficult to be reduced in size. For this reason, wavelength conversion laser devices using nonlinear optical effects which are highly efficient as video or medical laser have attracted attention. A nonlinear optical crystal having birefringence is required to obtain the nonlinear optical effects. SHG wavelength conversion elements have been used in which a ferroelectric nonlinear crystal such as a lithium niobate (LiNbO₃:PPLN) crystal is periodically polarization-reversed (e.g., see Patent Literature 1).

The SHG wavelength conversion element has a narrow wavelength phase matching temperature range of ±1° C. with respect to a fundamental wave, and thus requires temperature control using a temperature control mechanism such as a Peltier element (e.g., see Patent Literature 2).

Output from wavelength conversion elements using polarization-reversed highly nonlinear optical crystals such as LiNbO₃ or LiTaO₃ becomes unstable due to photorefractive damage. In particular, it is known that refractive index variation occurs in about several seconds to several minutes after the incidence of a second harmonic wave such as green light.

Meanwhile, it is reported that metal additives such as magnesium, indium, scandium, and zinc are added to suppress the occurrence of optical damage. In particular, MgO-doped LN crystals have high nonlinear optical constant and favorable crystallinity most promisingly. It is reported that the occurrence of optical damage can be suppressed in a congruent PPLN crystal containing at least 5.0 mol of a metal additive (e.g., see Patent Literatures 3 and 4, and Non-Patent Literature 1).

### CITATION LIST

### Patent Literatures

Patent Literature 1: Japanese Patent Application Laid-Open Publication No. 2001-144354

Patent Literature 2: Japanese Patent Application Laid-Open Publication NO. 8-171106

Patent Literature 3: Japanese Patent Application Laid-Open Publication No. 5-155694

Patent Literature 4: Japanese Patent Application Laid-Open Publication No. 7-89798

### Non-Patent Literature

Non-Patent Literature 1: “Appl. Phys. Lett.” vol. 44, p. 847, 1984, D. A. Bryan, et al.

### SUMMARY OF INVENTION

### Technical Problem

In the configuration of the related art, however, even though metal additives are added, when the output of the second harmonic wave of the wavelength conversion element becomes 1 W or larger, the refractive index of the wavelength conversion element increases with time. Thus, the phase matching temperature varies and the output decreases. In other words, in the configuration of the related art, at least 1 W of laser light outputted using the wavelength conversion element is disadvantageously reduced with time.

An object of the present invention is to solve the problem and suppress a reduction over time in output even when high-power laser light is outputted for a long period of time.

### Solution to Problem

In order to attain the object, the method for manufacturing a wavelength conversion element according to the present invention is a method for manufacturing a wavelength conversion element for converting a fundamental wave to a second harmonic wave, the method comprising the aging step of irradiating a nonlinear optical crystal with a first light beam having the same wavelength as the fundamental wave until the amount of variation per unit time in the phase matching temperature becomes a predetermined value or smaller while keeping the temperature of the nonlinear optical crystal at around the phase matching temperature after forming a periodical polarization-reversed structure in the nonlinear optical crystal.

Preferably, the output of the second harmonic wave in the aging step is not smaller than 0.5 W but smaller than 3 W.

Preferably, the integrated amount of output light of the second harmonic wave which is the product of the output of the second harmonic wave and aging time in the aging step is 600 W·hr or larger.

Preferably, the phase matching temperature is higher than 40° C. but not higher than 80° C.

The method for manufacturing a wavelength conversion element according to the present invention is a method for manufacturing a wavelength conversion element for converting a fundamental wave into a second harmonic wave, the method comprising the aging step of irradiating a nonlinear optical crystal with a first light beam having a wavelength in the vicinity of the wavelength of the fundamental wave and a second light beam having a wavelength in the vicinity of the second harmonic wave until the amount of variation per unit time in the phase matching temperature becomes a predetermined reference value or smaller after forming a periodical polarization-reversed structure in the nonlinear optical crystal.

Furthermore, the first light beam and the second light beam may enter in parallel to each other from a propagation direction thereof.

Furthermore, the first light beam and the second light beam may enter so as to cross each other in the nonlinear optical crystal.

Preferably, the method for manufacturing a wavelength conversion element further includes the heating step of retaining the nonlinear optical crystal at a predetermined heating temperature for predetermined heating time after forming the periodical polarization-reversed structure in the nonlinear optical crystal but before the aging step.

Preferably, the heating temperature is 85° C., and the heating time is 125 hours or longer.

Preferably, the wavelength conversion element is stored at 80° C. or lower after the aging step.

### Advantageous Effects of Invention

As described above, the wavelength conversion element is irradiated with the first light beam having the same wavelength as the fundamental wave after the formation of the periodical polarization-reversed structure in the nonlinear optical crystal, so that the variation of the phase matching temperature can be saturated beforehand. Thus, it is possible to suppress a reduction over time in output even when high-power laser light is outputted for a long period of time.

### BRIEF DESCRIPTION OF DRAWINGS

FIG. 1 is a flowchart showing a method for manufacturing a wavelength conversion element according to a first embodiment.

FIG. 2 is a cross-sectional view showing a process of the method for manufacturing a wavelength conversion element according to the first embodiment.

FIG. 3 is a cross-sectional view illustrating aging according to the first embodiment.

FIG. 4 shows the amount of variation per unit time in phase matching temperature relative to the irradiation time of a first light beam according to the first embodiment.

FIG. 5 shows the relationship of the amount of variation from the initial phase matching temperature relative to the integrated amount of output light of a second harmonic wave according to the first embodiment.

FIG. 6 shows the time variation of high-frequency output during a continuous operation of the wavelength conversion element.

FIG. 7 shows the amount of variation in the phase matching temperature relative to the storage temperature of the wavelength conversion element.

FIG. 8 is a cross-sectional view illustrating the aging step in a method for manufacturing a wavelength conversion element according to a second embodiment.

FIG. 9 is a cross-sectional view illustrating the aging step in a method for manufacturing a wavelength conversion element according to a third embodiment.

FIG. 10 is a flowchart showing a method for manufacturing a wavelength conversion element according to a fourth embodiment.

FIG. 11 is a cross-sectional view showing a wavelength conversion unit according to the fourth embodiment.

FIG. 12 is a flowchart showing a method for manufacturing a wavelength conversion element according to a fifth embodiment.

FIG. 13 shows the relationship of the amount of variation in the phase matching temperature of the wavelength conversion element from the initial stage relative to heating time in the heating step according to the fifth embodiment.

FIG. 14 shows a difference in phase matching temperature variation between when heating is performed and when heating is not performed.

### DESCRIPTION OF EMBODIMENTS

Background of the Invention

First, the background of the present invention will be described.

The inventors revealed by experiment that a reduction in output during high-power wavelength conversion, which is the problem to be solved by the present invention, was caused by a change in the phase matching temperature of a wavelength conversion element. The wavelength conversion element used in the experiment was a Mg-doped LiNbO₃ crystal having a periodically polarization-reversed structure with a period of about seven microns and a phase matching temperature of about 50° C. The phase matching temperature indicates a temperature at which the conversion efficiency from a fundamental wave to a second harmonic wave peaks, and the temperature varies depending on the wavelength of the fundamental wave and the period of polarization reversal. In the experiment, such a wavelength conversion element was used, and light with a fundamental wave of 7 W (having a wavelength of 1064 nm) was collected in the wavelength conversion element, to perform wavelength conversion for obtaining a second harmonic wave having a wavelength of 532 nm (about 2 W). At this point, when time variation in output was observed, the output was reduced to not higher than half of the initial output in several hours. Concurrently, the phase matching temperature of the wavelength conversion element became higher than the set temperature. The change of the phase matching temperature is thought to have been induced by refractive-index variation caused by the high-power fundamental wave and the second harmonic wave. This is conceived for the following reasons. First, it is reported that the refractive-index variation of radiated light is caused by optical damage. However, optical damage does not occur on light having a wavelength of 532 nm in Mg-doped LiNbO₃. Further, the refractive-index variation due to optical damage is a reversible phenomenon in which the refractive index returns to the original state when light radiation is stopped. In contrast, the variation of the phase matching temperature observed in the experiment was an irreversible phenomenon in which the refractive-index variation was kept even when the wavelength conversion element had been left at 50° C. for several months. Moreover, the refractive-index variation with temperature observed in the experiment occurred not when light having a wavelength of 532 nm or 1064 nm was singly radiated but when the fundamental wave and the second harmonic wave were concurrently radiated. It is considered from these factors that the reduction in output in the experiment, which had not been observed, was caused not by optical damage but by the refractive-index variation due to the concurrent radiation of the fundamental wave and the second harmonic wave. Furthermore, the phase matching temperature has been specific to a wavelength conversion element, and it has not been known that the phase matching temperature varies when the output of the fundamental wave is increased. Even though the phase matching temperature varied, wavelength conversion at another phase matching temperature did not cause a reduction in conversion efficiency. However, the variation of the phase matching temperature caused a difference between the set temperature and the phase matching temperature, thereby having reduced the output. As has been discussed, it is found that when a high-power second harmonic wave is outputted, it is important to avoid the variation of the phase matching temperature. The present invention is characterized in that the phase matching temperature is prevented from varying in the case where a high-power second harmonic wave is outputted.

The following will specifically describe embodiments of a method for manufacturing a wavelength conversion element according to the present invention with reference to the accompanying drawings.

### First Embodiment

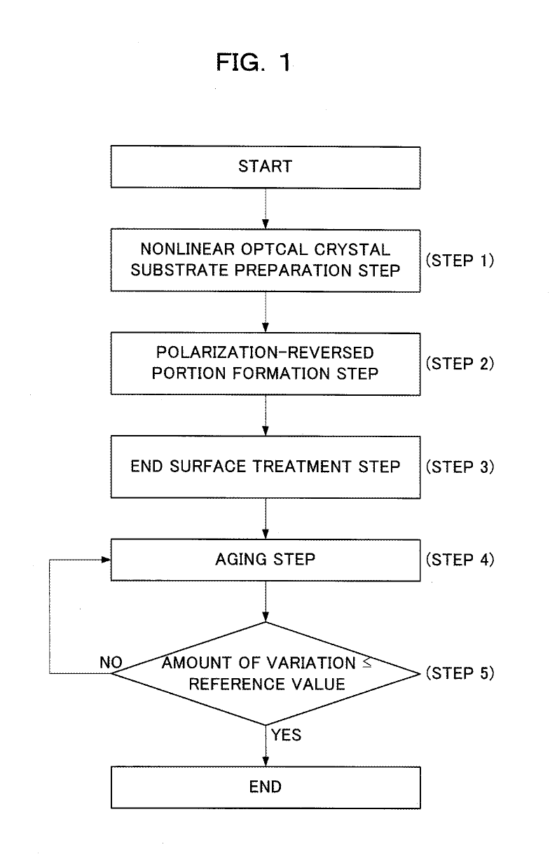

First, a method for manufacturing a wavelength conversion element according to a first embodiment of the present invention will be described with reference to FIGS. 1 to 7.

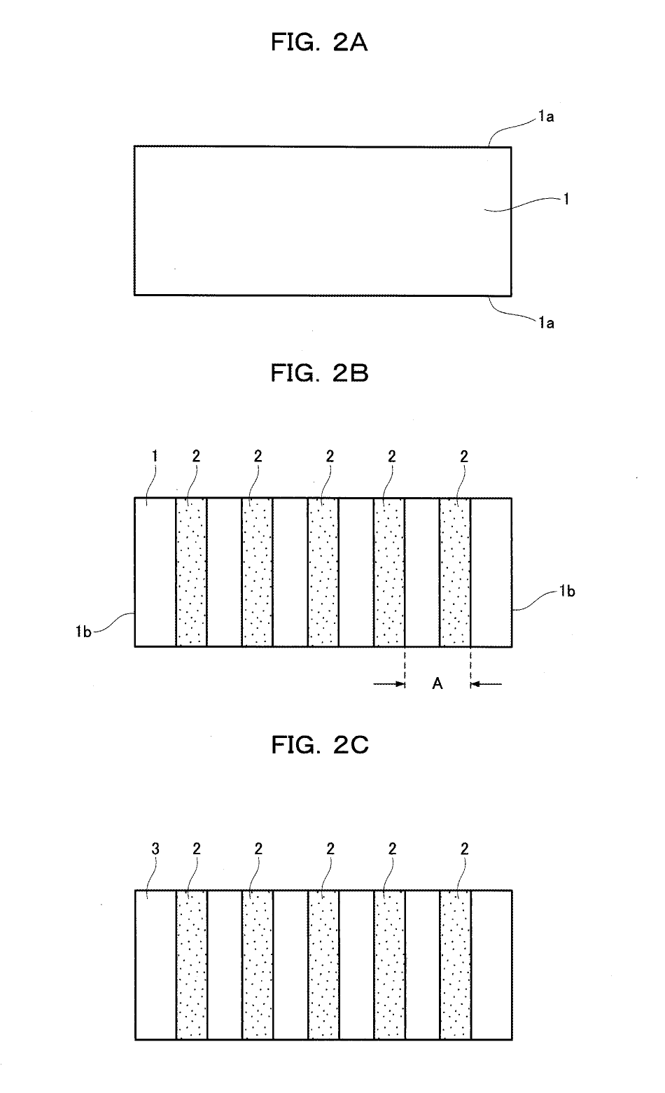

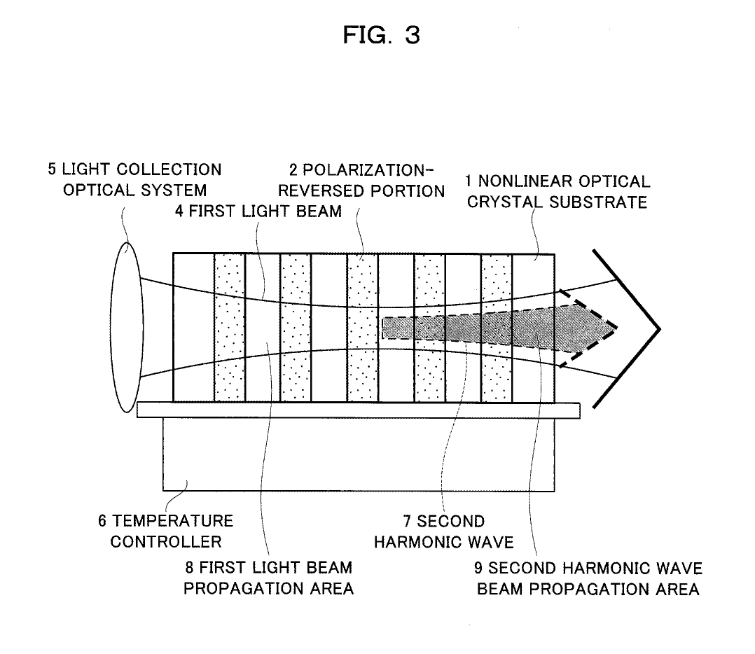

FIG. 1 is a flowchart showing the method for manufacturing a wavelength conversion element according to the first embodiment. FIGS. 2(a) to 2(c) are process cross-sectional views showing the process of the method for manufacturing a wavelength conversion element according to the first embodiment wherein FIG. 2(a) is a cross-sectional view of a nonlinear optical crystal substrate to be the material of the wavelength conversion element (step 1 in FIG. 1), FIG. 2(b) is a cross-sectional view of the nonlinear optical crystal substrate after the step of forming a polarization-reversed portion (step 2 in FIG. 1), and FIG. 2(c) is a cross-sectional view of the nonlinear optical crystal substrate after the aging step (step 3 in FIG. 1). FIG. 3 is a cross-sectional view illustrating the aging step according to the first embodiment.

The respective steps of FIG. 1 in the method for manufacturing a wavelength conversion element will be sequentially described.

### (1) Step 1: Nonlinear Optical Crystal Substrate Preparation Step

First, a nonlinear optical crystal substrate to be the material of a wavelength conversion element is prepared.

In the first embodiment, a wafer used for manufacturing a nonlinear optical crystal substrate 1 is a LiNbO₃ crystal which has a thickness of 1 mm and a diameter of 76.2 mm, contains 5.0 mol % of magnesium oxide, and has crystal orientation along the z axis.

FIG. 2(a) is the cross-sectional view of the nonlinear optical crystal substrate 1 used in the first embodiment. The nonlinear optical crystal substrate 1 is a rectangular parallelepiped with a thickness of about 1 mm, a width of about 10 mm, and a length of about 25 mm, which is obtained by cutting out the wafer with a thickness of 1 mm and a diameter of 76.2 mm. FIGS. 2(a) to 2(c) are the cross-sectional views of the rectangular parallelepiped (1 mm in thickness×25 mm in length).

### (2) Step 2: Polarization-Reversed Portion Formation Step

Next, polarization-reversed portions 2 are periodically formed inside the nonlinear optical crystal substrate 1 (in other words, a periodically polarization-reversed structure is formed).

In this step, first, an electrode pattern (not shown) is formed in portions of the nonlinear optical crystal substrate 1 where the polarization-reversed portions 2 are formed. In the first embodiment, the period of the polarization-reversed portions 2 (corresponding to A in FIG. 2(b)) is set to 7 μm in order to manufacture a wavelength conversion element 3 used for a laser light source device which inputs light having a wavelength of 1064 nm as a fundamental wave to the wavelength conversion element 3 and outputs a second harmonic wave having a wavelength of 532 nm from the wavelength conversion element 3.

In the formation of the electrode pattern, a sputtering device is used to form tantalum (Ta) thin films on surfaces 1a of the nonlinear optical crystal substrate 1, and a coater/developer is used to apply photoresists over the tantalum thin films. Next, a mask with a repeated pattern to be an electrode and the substrate with the photoresists applied thereon are made to contact each other and are exposed by an exposure unit. Thereafter, the photoresists with the pattern on the mask printed thereon are developed by the coater/developer and are etched to form the electrode pattern.

A pulsed electric field is applied to the electrode pattern to form the periodical polarization-reversed portions 2. Atom migration in the crystal due to the application of the pulsed electric field reverses the polarization orientation of the electrode pattern portion in the crystal orientation, so that the periodical polarization-reversed portions 2 are formed.

The electrode pattern is then removed. In the case where the electrode pattern is formed of tantalum, a fluoro-nitric acid solution is used.

As described above, the periodical polarization-reversed portions 2 are formed in the nonlinear optical crystal substrate 1 (in other words, the periodical polarization-reversed structure is formed) in this step as shown in FIG. 2(b).

### (3) Step 3: End Surface Treatment Step

Next, two ends 1b of the nonlinear optical crystal substrate 1 are optically polished, and then anti reflective films are formed on the optically polished surfaces by the sputtering device.

This allows light such as a laser beam to be inputted to or outputted from the nonlinear optical crystal substrate 1.

### (4) Step 4: Aging Step

As shown in FIG. 3, a first light beam 4 having the same wavelength as the fundamental wave is irradiated on the nonlinear optical crystal substrate 1 while the temperature of the nonlinear optical crystal substrate 1 is kept at around the phase matching temperature thereof. The phase matching temperature varies due to the irradiation of the fundamental wave, but the amount of variation is reduced as the irradiation time passes. Thus, as in step 5 which will be described below, the fundamental wave continues to be irradiated until the amount of variation per unit time in the phase matching temperature of the nonlinear optical crystal substrate 1 becomes a predetermined reference value or smaller.

As described above, the fundamental wave is an optical wave which is inputted to the wavelength conversion element 3 by the laser light source device for which the nonlinear optical crystal substrate 1 (that is, the wavelength conversion element 3 after the aging step) is used. In the first embodiment, as described above, the light having a wavelength of 1064 nm as the fundamental wave is inputted to the wavelength conversion element 3, and the second harmonic wave having a wavelength of 532 nm is outputted from the wavelength conversion element 3. Thus, the wavelength of the first light beam 4 is 1064 nm.

As shown in FIG. 3, a light collection optical system 5 is placed on the side of the surface of the nonlinear optical crystal substrate 1, on which the first light beam 4 is incident, to collect the first light beam 4 in the nonlinear optical crystal substrate 1.

The nonlinear optical crystal substrate 1 is placed on a temperature controller 6 such that the temperature of the nonlinear optical crystal substrate 1 is electronically variable. With this configuration, the temperature of the nonlinear optical crystal substrate 1 is controlled to around the phase matching temperature by the temperature controller 6.

As described above, the periodical polarization-reversed structure including the periodical polarization-reversed portions 2 is formed in the nonlinear optical crystal substrate 1. The collected first light beam 4 is converted to a second harmonic wave 7 in the nonlinear optical crystal substrate 1.

Further, an area where the first light beam 4 passes through the nonlinear optical crystal substrate 1 is set as a first light beam propagation area 8, and an area where the second harmonic wave 7 passes through the nonlinear optical crystal substrate 1 is set as a second harmonic beam propagation area 9.

### (5) Step 5: Aging Step Continuation Determination Step

The above-described aging step is performed while the amount of variation in the phase matching temperature of the nonlinear optical crystal substrate 1 with respect to time is determined. Specifically, the aging step is performed until the amount of variation per unit time in the phase matching temperature of the nonlinear optical crystal substrate 1 becomes the reference value or smaller.

At an initial stage when the first light beam 4 starts entering, the temperature of the nonlinear optical crystal substrate 1 is controlled with a target temperature set at the phase matching temperature before the aging step continuation determination step. Thereafter, the temperature of the nonlinear optical crystal substrate 1 is regularly varied by the temperature controller 6 (every ten hours in the first embodiment) to measure output at measured temperatures, and the temperature at which the output peaks is calculated as the phase matching temperature at that point. The calculated temperature is determined to be the phase matching temperature, the target temperature is changed, and the first light beam 4 continues entering while the nonlinear optical crystal substrate 1 is kept at the changed target temperature which is the phase matching temperature at that stage. At this point, a difference between the phase matching temperature the previous time (ten hours before) and the phase matching temperature this time is determined, and the time variation is calculated. When the variation (that is, the amount of variation per unit time in the phase matching temperature) is larger than the predetermined reference value, the first light beam 4 continues entering. When the variation (that is, the amount of variation per unit time in the phase matching temperature) is not larger than the predetermined reference value, the first light beam 4 stops entering.

As described above, after the completion of this step, the wavelength conversion element 3 (FIG. 2(c)) having an unvaried phase matching temperature can be manufactured.

In the first embodiment, the reference value of the amount of variation per unit time in the phase matching temperature of the nonlinear optical crystal substrate 1 is 0.0025° C./hr. The continuation of the aging step is determined such that the aging step (that is, the incidence of the first light beam 4) continues until the amount of variation per unit time in the phase matching temperature of the nonlinear optical crystal substrate 1 becomes 0.0025° C./hr or smaller.

The following will describe the reason that the reference value of the amount of variation per unit time in the phase matching temperature of the nonlinear optical crystal substrate 1 is 0.0025° C./hr.

In the case where the amount of variation per unit time in the phase matching temperature of the nonlinear optical crystal substrate 1 is larger than 0.0025° C./hr, since the variation with time of the phase matching temperature of the nonlinear optical crystal substrate 1 is extremely large, the variation with time of the phase matching temperature of the nonlinear optical crystal substrate 1 cannot be complemented by Auto Power Control (APC) which is generally used for the control of light outputted from a laser light source. However, in the case where the amount of variation per unit time in the phase matching temperature of the nonlinear optical crystal substrate 1 is not larger than 0.0025° C./hr, the variation with time of the phase matching temperature can be complemented. Conversely, in the case where the output is not complemented according to the variation of the phase matching temperature by APC, the reference value may be reduced, and the wavelength conversion element 3 may be subjected to the aging step such that a reduction in output according to the variation of the phase matching temperature during an operation can be tolerable to the laser light source device.

The above description is about the method for manufacturing a wavelength conversion element according to the first embodiment of the present invention. The wavelength conversion element manufactured thus is then mounted on a wavelength conversion unit and is used for the laser light source device.

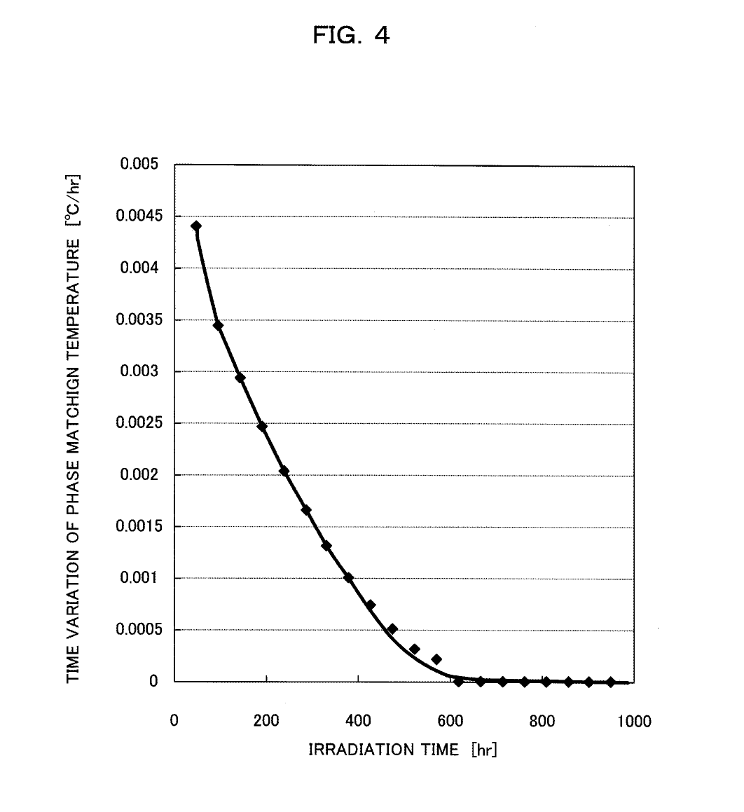

Further, FIG. 4 shows the amount of variation per unit time in the phase matching temperature with respect to the irradiation time of the first light beam according to the first embodiment. The graph shows the amount of variation per unit time in the phase matching temperature of the nonlinear optical crystal substrate 1 with respect to the irradiation time of the first light beam 4 in the case where the aging step is performed such that the second harmonic wave 7 of the wavelength conversion element 3 in the first embodiment becomes 1 W.

As shown in FIG. 4, the time variation of the phase matching temperature gradually decreases with the irradiation time of the first light beam 4, and the time variation of the phase matching temperature hardly occurs after the elapse of about 600 hours. It is also founded out that since the amount of variation is always on the plus side, the phase matching temperature gradually shifts (varies with time) from the initial state toward the high temperature side. This is because the variation with time of the refractive index of the wavelength conversion element is observed as the variation of the phase matching temperature. As shown in FIG. 4, the time variation of the phase matching temperature is a saturation phenomenon in which the variation of the phase matching temperature is saturated by the irradiation of the first light beam 4 for a predetermined period of time, thereby significantly improving the time variation of the phase matching temperature in practical use.

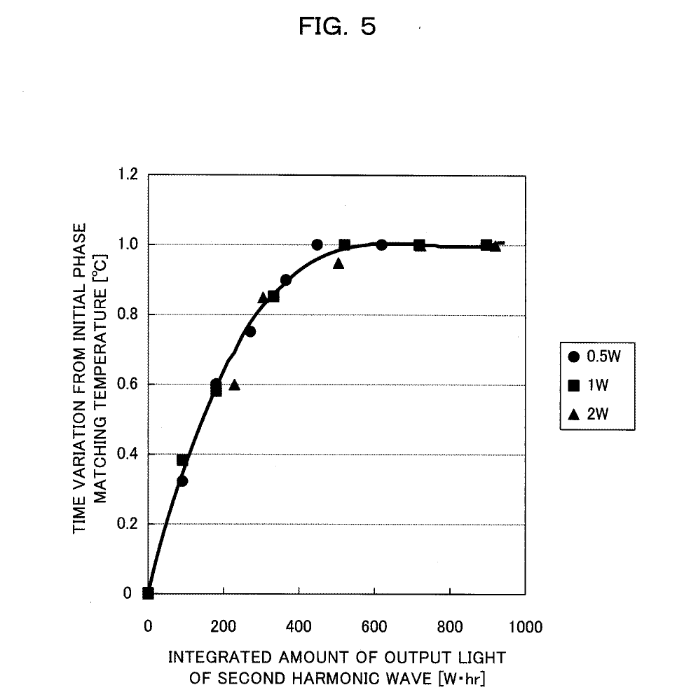

FIG. 5 shows the relationship of the amount of variation from the initial phase matching temperature relative to the integrated amount of output light of the second harmonic wave according to the first embodiment. The relationship of the amount of variation from the initial phase matching temperature relative to the integrated amount of output light of the second harmonic wave is shown with the output of the second harmonic wave 7 in the first embodiment set as parameters (0.5 W, 1 W, and 2 W). The integrated amount of output light of the second harmonic wave is the product (W·hr) of the output of the second harmonic wave (W) and the irradiation time of the first light beam 4 (hr). In FIG. 5, the abscissa indicates the integrated amount of output light of the second harmonic wave, and the ordinate indicates the amount of variation from the initial phase matching temperature.

As shown in FIG. 5, the amount of variation from the initial phase matching temperature depends on the integrated amount of output light of the second harmonic wave. This makes it possible to reduce the irradiation time of the first light beam by the radiation of the first light beam such that the output of the second harmonic wave becomes high.

Moreover, as shown in FIG. 5, in the case where the wavelength conversion element 3 of the first embodiment is used, when the integrated amount of output light of the second harmonic wave is 600 W·hr or larger, the variation of the phase matching temperature does not occur (is saturated) and the amount of variation from the initial phase matching temperature is 1° C. Thus, the aging step is performed beforehand such that the integrated amount of output light of the second harmonic wave becomes 600 W·hr or larger, and consequently the variation of the phase matching temperature is saturated and the phase matching temperature further increases by 1° C. Hence, the phase matching temperature is increased by 1° C. from the initial state during a practical operation, so that high-power laser light can be outputted for a long period of time while a reduction in output is suppressed.

Auto Power Control (APC) has been conventionally used to suppress a reduction in output light. The common APC can complement a reduction in the output of the second harmonic wave substantially equivalent to 0.4° C. which is the amount of variation in the phase matching temperature. Thus, the above-described aging step and the APC can be combined.

Specifically, as shown in FIG. 5, the amount of variation from the initial phase matching temperature is 1° C. in the case where the integrated amount of output light of the second harmonic wave is 600 W·hr or larger, and the amount of variation from the initial phase matching temperature is 0.6° C. in the case where the integrated amount of output light of the second harmonic wave is 200 W·hr. Thus, after the first light beam 4 is radiated when the integrated amount of output light of the second harmonic wave is 200 W·hr, the amount of variation with time in the phase matching temperature is 0.4° C. For this reason, the aging step can be beforehand performed with input light having the same wavelength as the fundamental wave of the first light beam 4 such that the integrated amount of output light of the second harmonic wave is 200 W·hr, and then APC can be performed during a practical operation. Such a control causes only a reduction in the output of the second harmonic wave equivalent to 0.4° C. which is the amount of variation in the phase matching temperature of the wavelength conversion element after the aging step. Thus, the reduction in the output can be complemented by APC to maintain high output for a long period of time. In other words, when the first light beam 4 is radiated such that the integrated amount of output light of the second harmonic wave is 200 W·hr or larger, the reduction over time in the output of the second harmonic wave can be suppressed to provide a sufficiently practical wavelength conversion element 3.

It is possible to carry out the above-described method for manufacturing a wavelength conversion element with other condition settings. The following will describe the details of the other conditions.

In the case where the first light beam was radiated such that the output of the second harmonic wave was below 0.5 W, a reduction over time in the output of the second harmonic wave was not suppressed. Further, a stable reduction over time in the output of the second harmonic wave could not be suppressed in the case where the output of the second harmonic wave was 3 W or larger. Thus, when radiating the first light beam 4, the output of the second harmonic wave has to be not smaller than 0.5 W but smaller than 3 W.

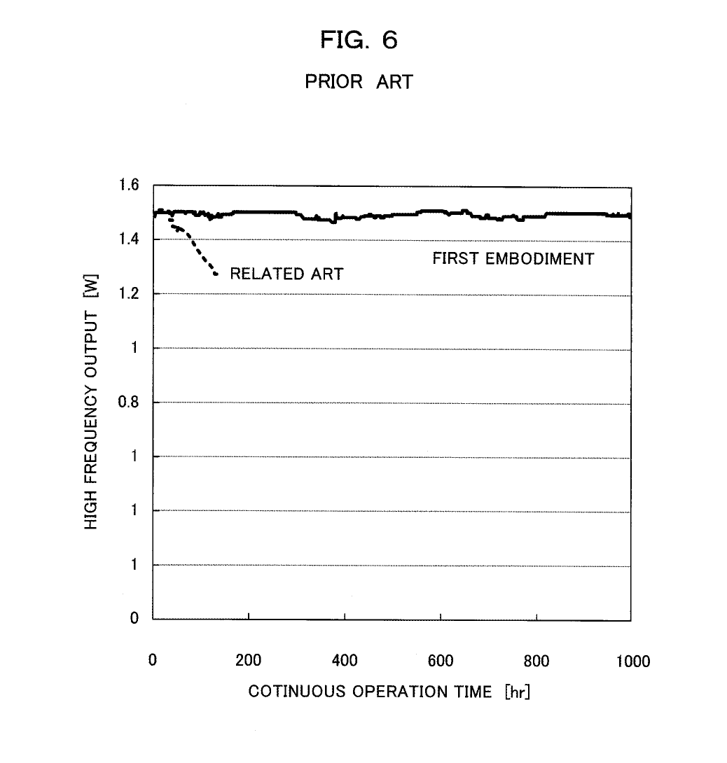

FIG. 6 shows the time variation of high frequency output during a continuous operation of the wavelength conversion element. A wavelength conversion element according to the related art is compared with the wavelength conversion element 3 of the first embodiment. The abscissa indicates continuous operation time, and the ordinate indicates high frequency output. The wavelength conversion element 3 of the first embodiment subjected to the aging step for 600 hours was used, in a state in which the first light beam 4 was adjusted such that the output of the second harmonic wave 7 was 1 W. The output of the second harmonic wave of the initial wavelength conversion element is 1.5 W.

As is clear from FIG. 6, the output of the wavelength conversion element according to the related art was 1.35 W after the elapse of 100 hours, a 10% reduction from the initial output. In contrast, a reduction in the output of the wavelength conversion element 3 according to the first embodiment could not be observed even after the elapse of 1000 hours. Thus, a reduction over time in the output of the second harmonic wave 7 could not be observed in the wavelength conversion element 3 subjected to the aging step according to the present invention even when the wavelength conversion element was operated for a long period of time. Evaluations were performed on the wavelength conversion element 3 subjected to the aging step for 200 hours in the state in which the first light beam 4 was adjusted such that the output of the second harmonic wave 7 was 1 W, that is, in a state in which the amount of variation in the phase matching temperature of the wavelength conversion element 3 was below 0.0025° C./hr which is the reference value of the amount of variation per unit time in the phase matching temperature. Similarly to the above wavelength conversion element subjected to the aging step for 600 hours, a reduction over time in the second harmonic wave output was not observed in the case of the above-described complementation with APC, even when the wavelength conversion element was operated for a long period of time.

As described above, the first light beam 4 having the same wavelength as the fundamental wave is radiated on the wavelength conversion element 3 after the periodical polarization-reversed structure is formed on the nonlinear optical crystal, so that the variation of the phase matching temperature can be saturated beforehand. Thus, a reduction over time in output can be suppressed even when high-power laser light is outputted for a long period of time.

Moreover, the period of the polarization-reversed portions 2 of the nonlinear optical crystal substrate 1 was changed to change the phase matching temperature of the wavelength conversion element 3, and effects on the phase matching temperature due to the radiation of the first light beam 4 were examined. Consequently, even though the aging step was performed such that the integrated amount was 1000 W·hr or larger, the amount of variation in the phase matching temperature was not saturated when the phase matching temperature was 40° C. or lower. Further, when the phase matching temperature exceeded 80° C., the effects caused by the radiation of the first light beam 4 could not be stably produced. According to the results, the period of the polarization-reversed portions 2 of the nonlinear optical crystal substrate 1 has to be designed such that the phase matching temperature is higher than 40° C. but not higher than 80° C.

Evaluations were performed on the storage temperature of the wavelength conversion element 3 subjected to the aging step. The wavelength conversion element 3 irradiated with the first light beam 4 such that the integrated amount was 600 W·hr was stored in high-temperature environment, and then the amount of variation in the phase matching temperature was evaluated. The phase matching temperature of the wavelength conversion element 3 shifted to the high temperature side by about 1° C. from the initial phase matching temperature with the irradiation of the first light beam 4.

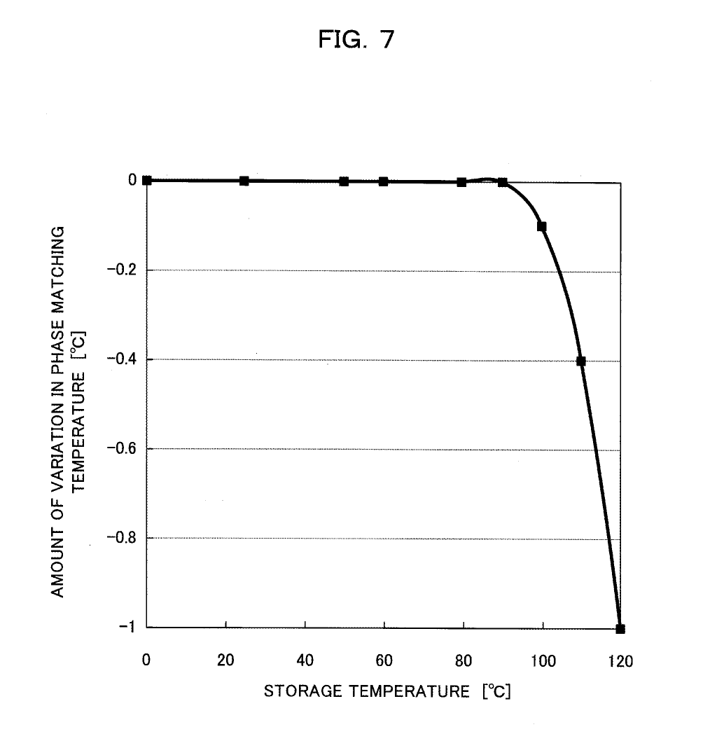

FIG. 7 shows the amount of variation in the phase matching temperature with respect to the storage temperature of the wavelength conversion element. The abscissa indicates the storage temperature, and the ordinate indicates the amount of variation in the phase matching temperature. The temperature profile of high-temperature storage was that the storage temperature was changed from a room temperature of 25° C. to a target temperature in two minutes, and was returned to the room temperature of 25° C. in two minutes after having being kept for 60 minutes.

As shown in FIG. 7, the phase matching temperature did not vary before the storage temperature reached 80° C., as compared with the phase matching temperature after the radiation of the first light beam 4. In the case where the storage temperature was 90° C. or higher, the amount of variation in the phase matching temperature before the aging step was completely recovered.

Thereafter, when the wavelength conversion element restored to the initial phase matching temperature was continuously operated again, the phase matching temperature shifted from the initial phase matching temperature to the high temperature side again. Thus, when the wavelength conversion element is restored to the initial phase matching temperature in the high-temperature environment after the aging step, the effects of the aging step are lost, thereby causing the variation of the phase matching temperature again. According to the result, the wavelength conversion element 3 has to be stored at a temperature of 80° C. or lower after the aging step.

In the first embodiment, the element is composed of LiNbO₃ having a congruent composition with a magnesium oxide content of 5.0 mol-%. However, the variation of the phase matching temperature can be saturated by the aging step under certain conditions, even when the element is composed of LiTaO₃ having a congruent composition with a magnesium oxide content of 5.0 mol %, or LiNbO₃, LiTaO₃, or KTiOPO₄ having a stoichiometric composition with a magnesium oxide content of at least 1 mol.

In the first embodiment, the wavelength conversion using the nonlinear optical effect of the optical element is explained by way of example. However, an optical element having a polarization-reversed structure for matching the phases of light using the period of the polarization reversal or matching the velocities of light and a microwave may be applied. Further, in the first embodiment, the conversion (generation of the second harmonic wave) from infrared light (1064 nm) into visible light (532 nm) is explained by way of example. However, a system for matching the phases of light with sum frequency generation or difference frequency generation using the period of the polarization reversal or parametric oscillation may be applied.

In the first embodiment, the wavelength of the first light beam 4 is 1064 nm but may be 900 nm to 1200 nm in the vicinity of 1064 nm.

### Second Embodiment

The following will describe a method for manufacturing a wavelength conversion element according to a second embodiment of the present invention.

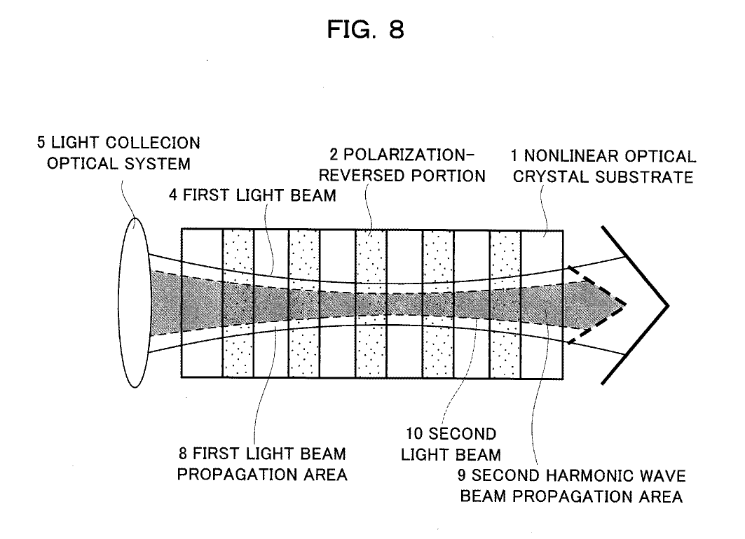

FIG. 8 is a cross-sectional view illustrating the aging step in the method for manufacturing a wavelength conversion element 3 according to the second embodiment.

The second embodiment is different from the first embodiment in that, in the aging step of the method for manufacturing the wavelength conversion element 3, a first light beam 4 having the same wavelength as a fundamental wave and a second light beam 10 having the same wavelength as a second harmonic wave are radiated on a nonlinear optical crystal substrate 1, so as to enter parallel to a direction in which the first light beam 4 and the second light beam 10 propagate, and the radiation continues until the amount of variation per unit time in the phasing matching temperature of the nonlinear optical crystal substrate 1 becomes a predetermined reference value or smaller. The steps explained in the first embodiment can be performed other than the method of light radiation in the aging step, and an explanation thereof is omitted.

In the second embodiment, for example, a light beam having a wavelength of 1064 nm can be used as the first light beam 4, and a light beam having a wavelength of 532 nm can be used as the second light beam 10.

The first light beam 4 and the second light beam 10 are radiated, so that the inside of the nonlinear optical crystal substrate 1 comes closer to a state in which the temperature is regulated and the second harmonic wave (532 nm) is being generated from the light having the wavelength of 1064 nm. Thus, the same state as in the aging step of the first embodiment can be obtained and the phase matching temperature can be saturated beforehand without keeping the temperature of the nonlinear optical crystal substrate 1 at around the phase matching temperature during the aging step, so that high output can be maintained in wavelength conversion. Hence, a temperature control system is not necessary for the nonlinear optical crystal substrate 1. As a result, the manufacturing cost for the aging step of the wavelength conversion element 3 can be reduced and the wavelength conversion element 3 can be easily manufactured.

In the second embodiment, the light having the same wavelength of 1064 nm as the fundamental wave is used as the first light beam 4 but may be light having a wavelength (900 nm to 1200 nm) in the vicinity of the wavelength of the fundamental wave.

In the second embodiment, the light having the wavelength of 532 nm is used as the second light beam 10 but may be light having a wavelength (350 nm to 600 nm) in the vicinity of the wavelength of the second harmonic wave.

### Third Embodiment

The following will describe a method for manufacturing a wavelength conversion element according to a third embodiment of the present invention.

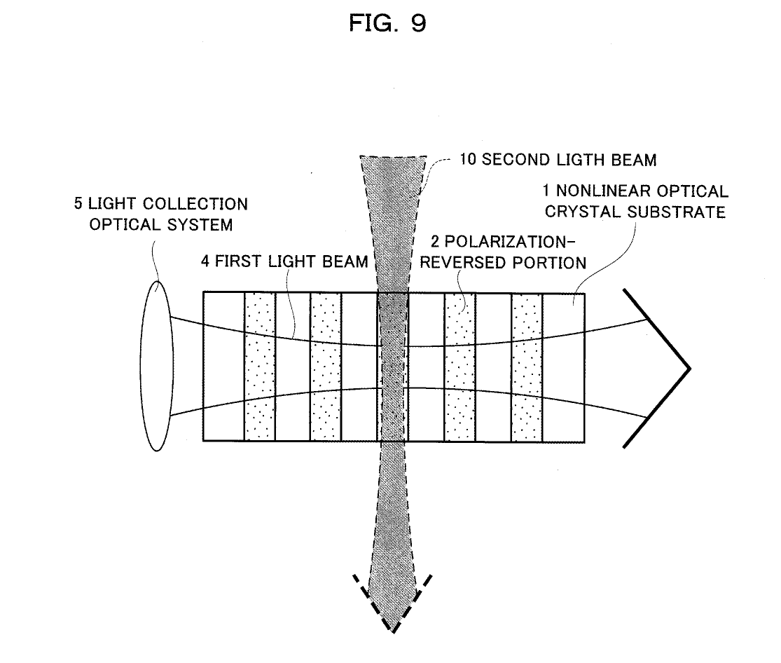

FIG. 9 is a cross-sectional view illustrating the aging step in the method for manufacturing a wavelength conversion element 3 according to the third embodiment.

The third embodiment is different from the second embodiment in that, in the aging step of the method for manufacturing the wavelength conversion element 3, a first light beam 4 having the same wavelength as a fundamental wave and a second light beam 10 having the same wavelength as a second harmonic wave are radiated on a nonlinear optical crystal substrate 1, so as to cross each other in the nonlinear optical crystal substrate 1, and the radiation continues until the amount of variation per unit time in the phase matching temperature of the nonlinear optical crystal substrate 1 becomes a predetermined reference value or smaller. In the third embodiment, the wavelength of the first light beam 4 is 1064 nm and the wavelength of the second light beam 10 is 532 nm.

This configuration eliminates the need to coaxially arrange the optical axes of the first light beam 4 and the second light beam 10 during the light incidence on the nonlinear optical crystal substrate 1. Further, the phase matching temperature can be saturated beforehand without keeping the temperature of the nonlinear optical crystal substrate 1 at around the phase matching temperature during the aging step, so that high output can be maintained in wavelength conversion, similarly to the second embodiment. Hence, the optical system of the first light beam 4 and the optical system of the second light beam 10 can be relatively easily designed, so that the manufacturing cost of the wavelength conversion element 3 can be reduced further than that in the second embodiment.

In the third embodiment, the first light beam 4 has the same wavelength of 1064 nm as the fundamental wave but may have a wavelength (900 nm to 1200 nm) in the vicinity of the wavelength of the fundamental wave.

In the third embodiment, the second light beam 10 has the wavelength of 532 nm but may have a wavelength (350 nm to 600 nm) in the vicinity of the second harmonic wave.

### Fourth Embodiment

The following will describe a method for manufacturing a wavelength conversion element according to a fourth embodiment of the present invention.

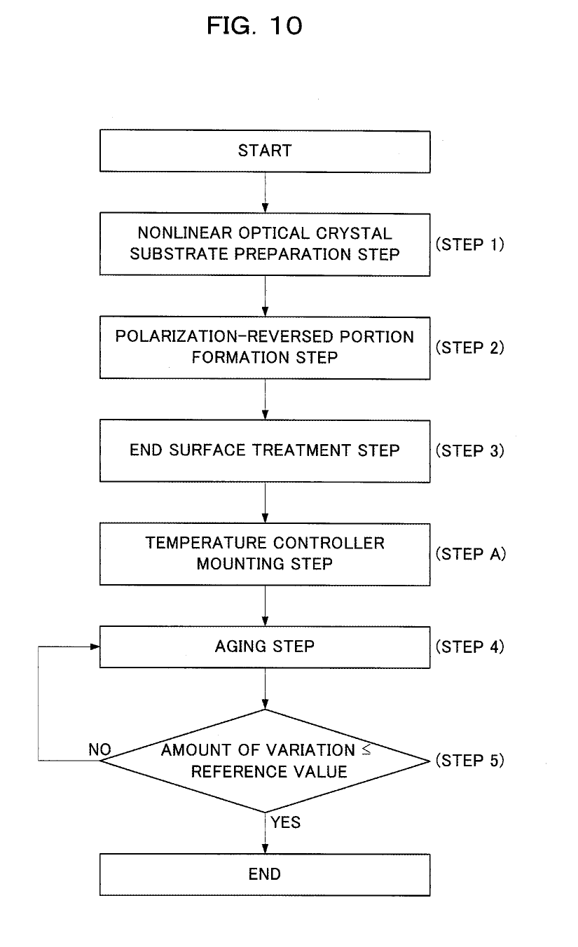

FIG. 10 is a flowchart showing the method for manufacturing a wavelength conversion element according to the fourth embodiment.

The fourth embodiment is different from the first embodiment in that, in the method for manufacturing a wavelength conversion element 3, a temperature controller mounting step (step A in FIG. 10) is provided after the formation of a periodical polarization-reversed structure on a nonlinear optical crystal but before the aging step. Further, the fourth embodiment is characterized in that the aging step can be performed with a nonlinear optical crystal substrate 1 incorporated into a wavelength conversion unit used for, for example, a laser light source device. The following will describe the temperature controller mounting step. Other steps are the same as the steps and conditions in the first embodiment, and an explanation thereof is omitted. Moreover, the nonlinear optical crystal substrate can be irradiated with a second light beam 10 as in the second and third embodiments.

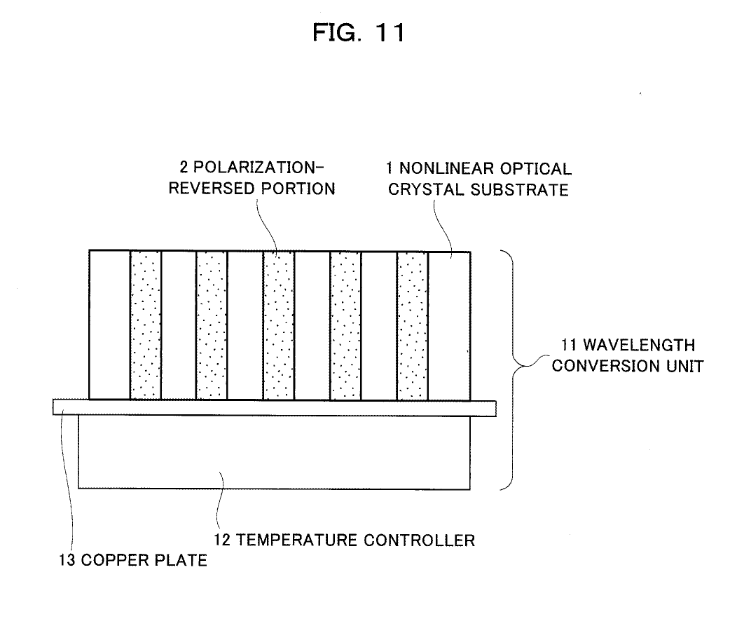

In the temperature controller mounting step (step A), the nonlinear optical crystal substrate 1 having a periodical polarization-reversed structure formed on a nonlinear optical crystal is mounted on a temperature controller 12. The aging step is performed with the nonlinear optical crystal substrate 1 put on the temperature controller 6 to evaluate the element characteristics in FIG. 3 of the first to third embodiments. After the aging step, the wavelength conversion element 3 fixed to the separately provided wavelength conversion unit is used for, for example, the laser light source device which is a final product. In contrast, FIG. 11 of the fourth embodiment is different from FIG. 3 in that the nonlinear optical crystal substrate 1 is bonded and fixed to a copper plate 13 of the temperature controller 12 and is mounted as the wavelength conversion unit, and then the aging step is performed.

FIG. 11 is a cross-sectional view showing the wavelength conversion unit according to the fourth embodiment.

As shown in FIG. 11, a wavelength conversion unit 11 includes the copper plate 13 bonded onto the temperature controller 12 with an adhesive, and the nonlinear optical crystal substrate 1 having the periodical polarization-reversed structure bonded onto the copper plate 13 with an adhesive.

Such a manufacturing method enables the temperature controller 12 of the wave conversion unit 11 to control the temperature of the nonlinear optical crystal substrate 1 in the aging step 4, as compared to the first embodiment. Thus, it is possible to eliminate the step of incorporating the nonlinear optical crystal substrate 1 into the wavelength conversion unit 11 at the stage of manufacturing a final product. As a result, the wavelength conversion unit 11 can be easily manufactured.

### Fifth Embodiment

The following will describe a method for manufacturing a wavelength conversion element according to a fifth embodiment of the present invention.

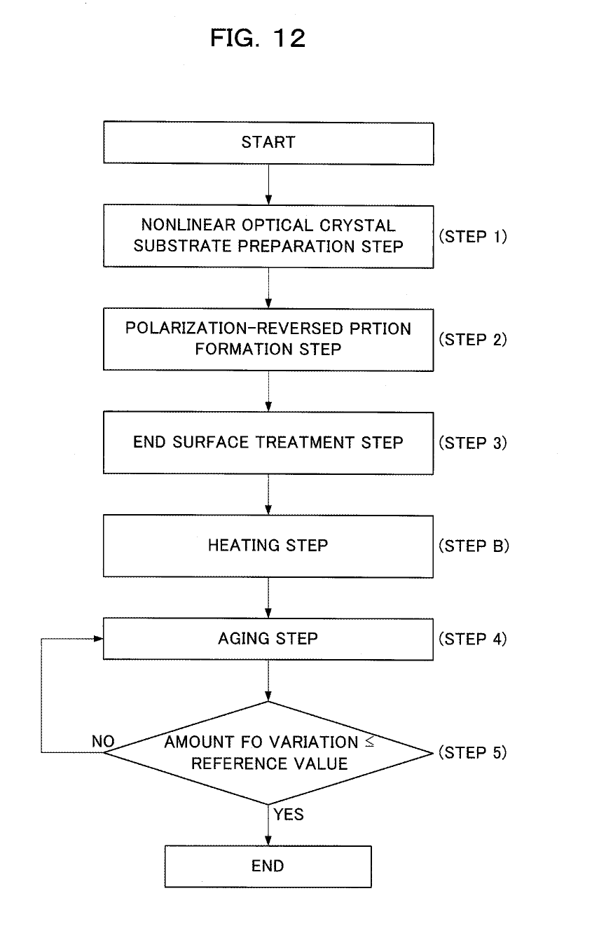

FIG. 12 is a flowchart showing the method for manufacturing a wavelength conversion element according to the fifth embodiment.

The fifth embodiment is different from the first embodiment in that, in the method for manufacturing a wavelength conversion element 3, a heating step (step B) is provided after the formation of a periodical polarization-reversed structure on a nonlinear optical crystal but before the aging step. The following will describe the heating step. Other steps are the same as the steps and conditions in the first embodiment, and an explanation thereof is omitted. Further, a nonlinear optical crystal substrate can be irradiated with a second light beam 10 as in the second and third embodiments, and can be mounted on a temperature controller as in the fourth embodiment.

In the heating step (step B), a nonlinear optical crystal substrate 1 having a periodical polarization-reversed structure formed on a nonlinear optical crystal is placed on a temperature controller 6 as shown in FIG. 3, and heat is applied to the nonlinear optical crystal substrate under the conditions described below.

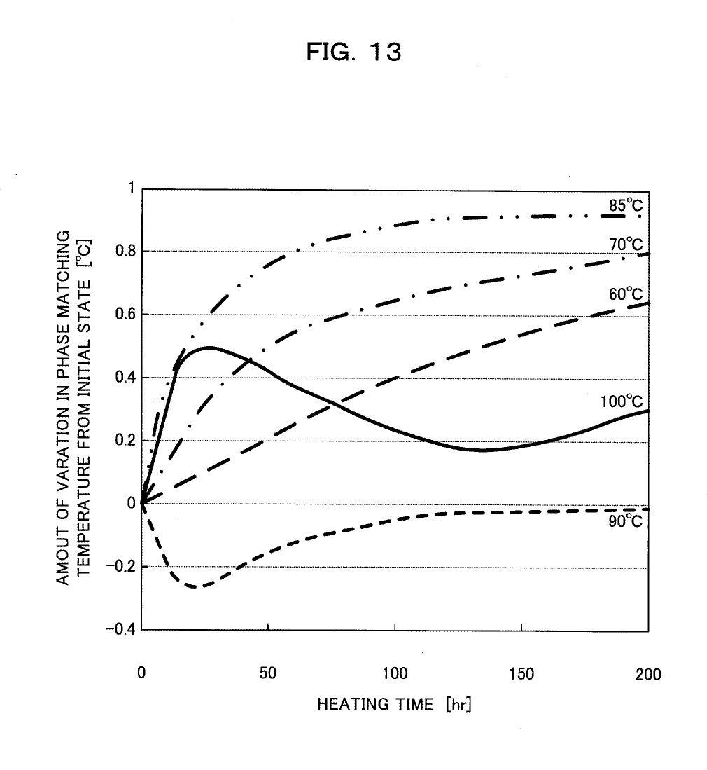

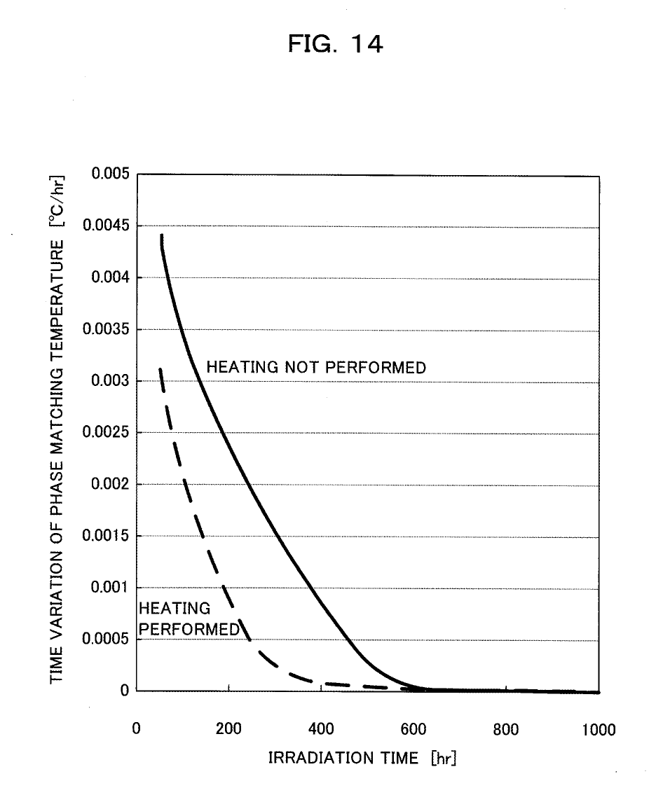

Effects of the fifth embodiment will be described with reference to FIGS. 13 and 14.

FIG. 13 shows the relationship of the amount of variation in the phase matching temperature of the wavelength conversion element from the initial stage relative to heating time in the heating step according to the fifth element. In FIG. 13, heating temperatures in the heating step of 60° C., 70° C., 85° C., 90° C., and 100° C. are parameters.

As shown in FIG. 13, in the case where the heating temperature is 60° C., 70° C., 85° C., or 100° C., the phase matching temperature shifts to the high temperature side. Further, in the case where the heating temperature in the heating step is 85° C., the phase matching temperature is saturated in about 125 hours (the variation of the phase matching temperature becomes constant). Further, in the case where the heating temperature in the heating step is 60° C. or 70° C., the heating time becomes longer but the phase matching temperature comes close to the same saturation temperature. Thus, the heating step for at least 125 hours is required. However, in the case where the heating temperature in the heating step is 90° C., the phase matching temperature shifts to the low temperature side, and then specifically returns to the initial state. Furthermore, in the case where the heating temperature in the heating step is 100° C., the phase matching temperature shifts to the high temperature side in 20 hours, but when the heating time is extended, the phase matching temperature conversely shifts to the low temperature side, exhibiting a specific behavior. As described above, in the case where the heating temperature is 90° C. or higher, the amount of variation in the phase matching temperature is not stable and stable variation in the phase matching temperature cannot be obtained.

The following will describe a comparison between when heating is performed and when heating is not performed (the first embodiment) in the amount of variation per unit time in the phase matching temperature of the nonlinear optical crystal substrate 1 relative to the irradiation time of a first light beam 4.

FIG. 14 shows a difference in phase matching temperature variation between when heating is performed and when heating is not performed, and the amount of variation per unit time in the phase matching temperature of the nonlinear optical crystal substrate 1 with respect to the irradiation time of the first light beam 4 according to the fifth embodiment. In the fifth embodiment, the heating temperature in the heating step was 85° C., the heating time was 150 hours, and the aging step was performed with a first light beam 4 having such an amount of light that a second harmonic wave 7 became 1 W. As shown in FIG. 14, when heating was not performed, as compared to when heating was performed, the time variation was smaller and the time until the saturation of the phase matching temperature was longer. Thus, in the method for manufacturing the wavelength conversion element 3, the predetermined heating step is provided after the formation of a periodical polarization-reversed structure on the nonlinear optical crystal but before the aging step, so that the time of the aging step can be shortened. It is noted from the above-described experiment results that when heating is performed at a heating temperature of 60° C. to 85° C. for heating time of 125 hours or longer, the aging time can be shortened. It is also noted that the heating temperature is preferably 85° C.

The results shown in FIGS. 13 and 14 will be discussed.

Generally, a periodical polarization-reversed structure is formed by an external electric field, so that areas having a spontaneous polarization reversed with a micron-order short-period structure are adjacent to each other to form LiNbO₃ and LiTaO₃ crystals. The boundary between the areas having the reversed spontaneous polarization is called a domain wall. Further, the spontaneous polarization of the crystal is reversed, so that the crystal has a distortion therein. The distortion includes charge localization caused by the movement of lithium ions and a structural distortion occurring on the domain wall due to a change of the crystal structure. The charge localization forms charge distribution in the direction of the spontaneous polarization and generates an electric field facing the spontaneous polarization. The electric field reduces the refractive index of the crystal due to electro-optical effects. The charge localization is trapped in a shallow impurity level and is gradually discharged with time, so that electric localization is reduced. This is considered to be a cause for the variation with time in which the phase matching temperature of the wavelength conversion element gradually increases over a long period of time. The movement of charge trapped in the impurity level is effectively accelerated by increasing the temperature to accelerate a reduction in the charge localization. This is the reason that the heating step of the present invention is effective. Heating is performed at 85° C. or lower, so that the reduction in the charge localization caused by the polarization reversal or the heating step can be accelerated and the variation with time of the phase matching temperature can be suppressed. In contrast, the heating temperature was increased to higher than 90° C., so that the refractive index of the crystal was reduced again and the variation with time was reset to the original state (a state before the variation with time). This is because free charge due to the crystal defects is rapidly increased when the temperatures of the LiNbO₃ and LiTaO₃ crystals are increased to 90° C. or higher. The temperature increase to 90° C. or higher is known as a cause for the reduction of optical damage. The increased free charge constitutes the state of charge localization in the crystal again with the internal electric field of the spontaneous polarization. Thus, the variation with time is considered to be reset to the start condition.

As described above, in the method for manufacturing a wavelength conversion element, the periodical polarization-reversed structure is formed in the nonlinear optical crystal and the heating step is provided before the aging step, so that the reduction of the charge localization caused by the polarization reversal or the heating step can be accelerated. Thus, time for the aging step can be shortened.

In the fifth embodiment, heating is performed by the temperature controller 6 but may be performed by, for example, a thermostatic bath.

### INDUSTRIAL APPLICABILITY

The present invention is useful for, for example, a method for manufacturing a second harmonic wave generation wavelength conversion element which can suppress a reduction over time in output and output a stable second harmonic wave in the long term and is used for, for example, a laser light source device.

1. A method for manufacturing a wavelength conversion element for converting a fundamental wave to a second harmonic wave, the method comprising an aging step of irradiating a nonlinear optical crystal with a first light beam having the same wavelength as the fundamental wave until an amount of variation per unit time in a phase matching temperature becomes a predetermined value or smaller while keeping a temperature of the nonlinear optical crystal at around the phase matching temperature after forming a periodical polarization-reversed structure in the nonlinear optical crystal.

2. The method for manufacturing a wavelength conversion element according to claim 1, wherein output of the second harmonic wave in the aging step is not smaller than 0.5 W but smaller than 3 W.

3. The method for manufacturing a wavelength conversion element according to claim 1, wherein an integrated amount of output light of the second harmonic wave which is a product of the output of the second harmonic wave and aging time in the aging step is 600 W hr or larger.

4. The method for manufacturing a wavelength conversion element according to claim 1, wherein the phase matching temperature is higher than 40° C. but not higher than 80° C.

5. A method for manufacturing a wavelength conversion element for converting a fundamental wave into a second harmonic wave, the method comprising an aging step of irradiating a nonlinear optical crystal with a first light beam having a wavelength in the vicinity of a wavelength of the fundamental wave and a second light beam having a wavelength in the vicinity of the second harmonic wave until an amount of variation per unit time in a phase matching temperature becomes a predetermined reference value or smaller after forming a periodical polarization-reversed structure in the nonlinear optical crystal.

6. The method for manufacturing a wavelength conversion element according to claim 5, wherein the first light beam and the second light beam enter in parallel to each other from a propagation direction thereof.

7. The method for manufacturing a wavelength conversion element according to claim 5, wherein the first light beam and the second light beam enter so as to cross each other in the nonlinear optical crystal.

8. The method for manufacturing a wavelength conversion element according to claim 1, further comprising a heating step of retaining the nonlinear optical crystal at a predetermined heating temperature for predetermined heating time after forming the periodical polarization-reversed structure in the nonlinear optical crystal but before the aging step.

9. The method for manufacturing a wavelength conversion element according to claim 8, wherein the heating temperature is 85° C., and the heating time is 125 hours or longer.

10. The method for manufacturing a wavelength conversion element according to claim 1, wherein the wavelength conversion element is stored at 85° C. or lower after the aging step.
